(19) United States
(12) Patent Application Publication
(10) Pub. No.: US 2006/0110017 A1
(43) Pub. Date: May 25, 2006

(54) Method for spinal disease diagnosis based on image analysis of unaligned transversal slices

(75) Inventors: Ming-Dar Tsai, Jhongli City (TW); Ming-Shium Hsieh, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Chung Yuan Christian University

(21) Appl. No.: 11/178,938

(22) Filed: Jul. 11, 2005

(30) Foreign Application Priority Data
Nov. 25, 2004 (TW) 93136287

(51) Int. Cl. G06K 9/00

(52) U.S. Cl. 382/128; 382/154

(57) ABSTRACT

A method for spinal disease diagnosis based on image analysis of unaligned transversal slices, reconstructing a 3D image of a bone structure. At least one transverse slice is extract from the 3D image. Vertices of a triangulated isosurface are obtained from the transverse slice. The vertices are transformed to correct positions of unaligned slices in the bone structure. A surface normal of the vertices is calculated according to the correct positions. The triangulated isosurface is reconstructed by interpolating according to the vertices.

### BACKGROUND

The present invention relates to image analysis methods, and more particularly, to methods for spinal disease diagnosis based on image analysis of unaligned transversal slices.

Techniques for the diagnosis of spinal diseases using aligned computed tomography (CT) or magnetic resonance imaging (MRI) slices cannot achieve a high accuracy rate since the constant interval slices do not correspond to the anatomic and physiological curves of the spine and cannot precisely evaluate the orientation-sensitive spinal structures, such as disc spaces, vertebral bodies, and spinal cords.

Unaligned transverse CT or MRI slices in the spinal disease management indicate that arbitrary attitude and interval slices can be set to be orthogonal to every spinal structure. Therefore, a more complete cross section and accurate geometric data relating to the orientation-sensitive structures can be obtained from the unaligned slices. Generally, the unaligned slices are set to perpendicularly pass through multi-level intervertebral discs and vertebral bodies and become a routine for spinal diseases originating from the spinal cord, bones, and tumors, and intervertebral discs. The characteristics of disc herniations and discitis are resolved using the unaligned slices to estimate positions of bulging and infection on these discs. The unaligned slices can resolve fractured or compressed vertebral bodies to estimate burst and fracture fragments, canal compressions, and the bone dislocation, scoliosis, kyphosis and lorodos is diagnosed based on the spinal curves. The tumors in spinal bones, cord and disc spaces can also be resolved using the unaligned slices to accurately evaluate tumor positions and volumes, thus enabling the management of tumor dissection and bone grafting. Spinal diseases may be interrelated to each other. For example, an inside bone tumor may fracture a vertebral bone, resulting in changes in the spinal curve. Additionally, an abnormal spinal curve may result in compressions to disc spaces or the spinal cord and canal.

Three-dimensional graphics techniques comprise visualization and feature recognition of anatomic structures based on the volume data constituted by aligned slices. Visualization comprises volume rendering and surface rendering. Volume rendering is an additive reprojection method, accumulating a color and attenuation assigned to each voxel. Surface rendering extracts isosurfaces of anatomic structures and shades the isosurfaces. The described methods allow clear observation of anatomic features and are compatible with standard pipelines using conventional 3D graphics software and hardware. For a general medical volume (usually under one hundred slices), the reconstructed isosurfaces may contain one million triangles, rendered out in 1 second even using a PC platform. The marching cube (MC) method is the most popular 3D isosurface reconstruction technique and is extended to avoid holes in the isosurfaces, detect separate isosurfaces, and reveal sharp areas. Feature recognition techniques extract abnormal anatomic structures to automate diagnostic process. Tsai et al disclose problem oriented feature recognition methods, approximating elliptic intervertebral disc boundaries as B-spline radii and closed curves associated with concave and convex features on respective 2D slices. The convex features are matched into a disc herniation feature to diagnose herniated inter-vertebral disc (HIVD). Hsieh et al approximate the boundary of a vertebral body on a transverse slice as a radius and closed curve associated with a concave feature enclosing the canal. The concave feature is analyzed to diagnose canal compression. The 2D approximated vertebral body boundaries on respective multiple transverse slices are combined to reconstruct the spine morphology for diagnosis of deformities such as kyphosis and scoliosis.

Tsai and Hsieh disclose a 3D reconstruction technique for multi-axial slices in which several sets of aligned slices intersect in the volume of interest. A discrete ray tracing algorithm is adopted to render the reconstructed local quadratic isosurfaces. Payne and Toga developed a 3D reconstruction technique for self-crossing slices with arbitrary attitudes, drawing the contours of structures and giving directions for the contours on the slices. The method verifies the consistency of the contours within and between the slices and constructs a triangulated isosurface model based on the contours. Max et al. disclose a set of complicated methods for volume rendering curvilinear and unstructured voxels. Shapes of the voxels are not cubic but may be triangular or pyramidal.

In view of drawbacks of conventional diagnosis methods, the invention discloses an improved method for spinal disease diagnosis based on image analysis of unaligned transversal slices.

### SUMMARY

Methods for spinal disease diagnosis based on image analysis of unaligned transversal slices are provided. In an embodiment of such a method, at least one transverse slice is extracted from a 3D image. Vertices of a triangulated isosurface are obtained from the transverse slice. The vertices are transformed to correct positions of unaligned slices in a bone structure. A surface normal of the vertices is calculated according to the correct positions. The triangulated isosurface is reconstructed by interpolating according to the vertices.

Also disclosed is another method for spinal disease diagnosis based on image analysis of unaligned transversal slices. In an embodiment of such a method, the boundary of the bone structure is approximated as a radius. Features and centers of a bone structure are transformed to correct positions on unaligned slices thereof. Attitudes and lengths of the bone structure are determined according to the centers on the unaligned slices. Diagnosis is implemented based on the positions, attitudes, lengths, abnormalities, and volumes of the bone structure.

A detailed description is given in the following embodiments with reference to the accompanying drawings.

### BRIEF DESCRIPTION OF THE DRAWINGS

The invention can be more fully understood by reading the subsequent detailed description and examples of embodiments thereof with reference made to the accompanying drawings, wherein:

FIG. 1 is a flowchart of an embodiment of a 3D reconstruction method of the present invention;

FIG. 2 is a flowchart of an embodiment of a feature recognition method of the present invention;

FIG. 3A is a schematic view of a cubic cell with 8 voxels as vertices;

FIG. 3B is a schematic view of a cuboid cell with voxels scaled by a scaling transformation to obtain world coordinates;

FIG. 3C is a schematic view of an unaligned cell with each voxel transformed by a different transformation;

FIG. 4 is a schematic view of geometric meanings of concatenating transformations for points on an unaligned slice to world coordinates;

FIG. 5A is a schematic view of temporary neighbors for determination of the surface normal at a voxel;

FIG. 5B is a schematic view of an embodiment of determination of the temporary voxel;

FIG. 5C is a schematic view of an error case, wherein neighboring and current slices intersect;

FIG. 6A is a schematic view of HIVD feature recognition on a 2D slice;

FIG. 6B is a schematic view of 3D HIVD reconstruction from 2D HIVD on transverse slices;

FIG. 7A is a schematic view of recognition for canal, canal compression and center of a vertebral body on 2D slice;

FIG. 7B is a schematic view of translation abnormality at an intervertebral disc;

FIG. 7C is a schematic view of angular abnormality at an intervertebral disc;

FIG. 7D is a schematic view of translation abnormality inside a vertebral body;

FIG. 7E is a schematic view of angular abnormality inside a vertebral body;

FIG. 8A is a schematic view of aligned volumes with horizontal and constant intervals;

FIG. 8B is a schematic view of unaligned volumes of oblique slices with constant intervals and angles;

FIG. 8C is a schematic view of unaligned volumes with arbitrary angles and intervals;

FIG. 9A is a schematic view of a 3D image of aligned volumes with horizontal and constant intervals;

FIG. 9B is a schematic view of a 3D image of oblique volumes with constant angles and intervals;

FIG. 9C is a schematic view of a 3D image of arbitrary volumes with arbitrary angles and intervals;

FIG. 9D is a schematic view of a 3D image of aligned volumes for interpolation of horizontal and constant intervals;

FIG. 9E is a schematic view of 3D image of oblique volumes for interpolation of constant angles and intervals;

FIG. 9F is a schematic view of a 3D image of arbitrary volumes for interpolation of arbitrary angles and intervals;

FIG. 9G is a schematic view of a 3D image of aligned volumes with horizontal and constant intervals after argumentation;

FIG. 9H is a schematic view of a 3D image of oblique volumes with constant angles and intervals after argumentation;

FIG. 9I is a schematic view of a 3D image of arbitrary volumes with arbitrary angles and intervals after argumentation;

FIG. 10A is a schematic view of disc herniation with the largest herniation radius 4.8% larger than the normal radius;

FIG. 10B is a schematic view of disc herniation with the largest herniation radius 8.77% larger than the normal radius;

FIG. 11A is a schematic view of aligned volumes;

FIG. 11B is a schematic view of unaligned volumes of oblique slices with constant intervals and angles;

FIG. 11C is a schematic view of unaligned volumes with arbitrary angles and intervals;

FIG. 12A is a schematic view of a 3D image of aligned volumes with horizontal and constant intervals;

FIG. 12B is a schematic view of a 3D image of oblique volumes with constant angles and intervals;

FIG. 12C is a schematic view of a 3D image of arbitrary volumes with arbitrary angles and intervals;

FIG. 12D is a schematic view of a 3D image of aligned volumes with horizontal and constant intervals after argumentation;

FIG. 12E is a schematic view of a 3D image of oblique volumes with constant angle and intervals after argumentation;

FIG. 12F is a schematic view of a 3D image of arbitrary volume with arbitrary angles and intervals after argumentation;

FIG. 13A is a schematic view of unaligned volumes of oblique slices with constant intervals and angles;

FIG. 13B is a schematic view of unaligned volumes with arbitrary angles and intervals;

FIG. 14A is a schematic view of an oblique 3D image of an oblique volume without inferior slices below C5;

FIG. 14B is a schematic view of f a lateral 3D image of an oblique volume after argumentation;

FIG. 14C is a schematic view of a lateral 3D image of arbitrary volume after argumentation;

FIG. 15A is a schematic view of canal compression at C4 of an arbitrary volume with 27.8% maximum compression comparing with a canal diameter; and

FIG. 15B is a schematic view of canal compression at C5 of an oblique volume with 24.0% maximum compression to canal diameter.

### DETAILED DESCRIPTION

The present invention discloses a method for spinal disease diagnosis based on image analysis of unaligned transversal slices.

The image analysis method of the present invention utilizing both 3D reconstruction and feature recognition methods using unaligned transversal slices automatic diagnostic processes of spinal diseases, in which the unaligned slices have arbitrary angles and intervals but do not intersect. The 3D reconstruction method extends the MC method to generate vertices of triangulated isosurfaces and reconstructs the isosurfaces according to the vertices. The feature recognition method analyzes 2D transversal slices to estimate the presence and extent of disc herniation and canal compression, and calculate the spinal curvature to estimate curvature deformities. A prototype system using the method of the invention can be used as a qualitative and quantitative tool for the diagnosis of various spinal diseases using unaligned transverse slices.

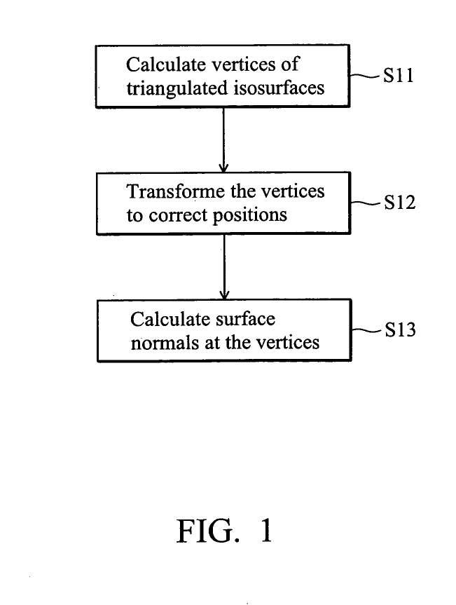

FIG. 1 is a flowchart of the 3D reconstruction method of the present invention.

The 3D reconstruction method first calculates the vertices (sample points) of triangulated isosurfaces (step S11). Next, the vertices are transformed to correct positions on unaligned slices using a transformation formula (step S12). Surface normals at the vertices determining image quality are calculated (step S13). In addition, the slices with no intersections in ROIs are also detected during the surface normal computation.

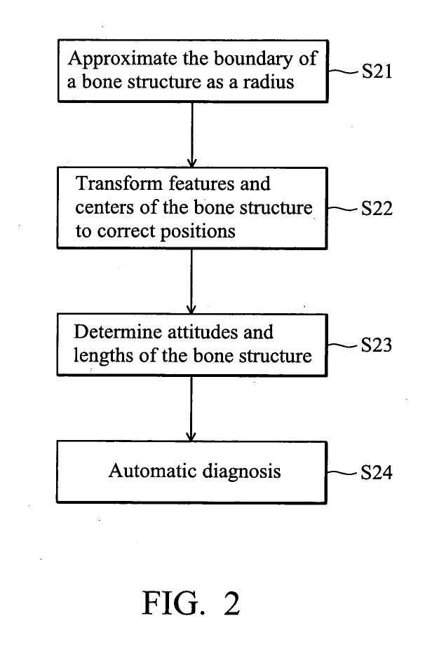

FIG. 2 is a flowchart of the feature recognition method of the present invention. The feature recognition method approximates the boundary of an intervertebral disc or a vertebral bone (body) as a radius and closed B-spline curves associated with concave and convex features (step S21), and transforms the features and centers of the body to correct positions on the unaligned slices (step S22). Attitudes and lengths of the body are determined according to the body centers on all the slices (step S23). Automatic diagnosis is implemented based on the positions and volumes of disc herniation, fractured bones, or compressed canal or tumor, and the attitudes and lengths of the body (step S24).

Isosurface reconstruction for unaligned slices is described as follows.

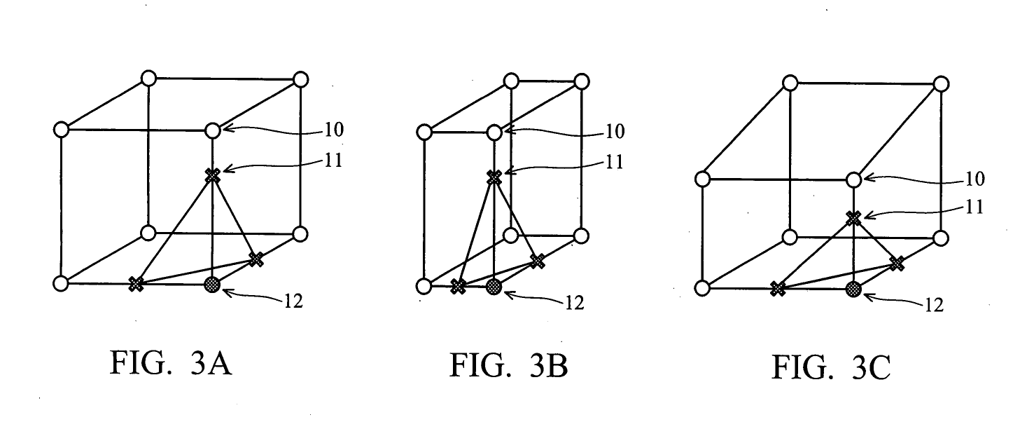

The MC method considers voxel centers as vertices of a cube, interpolates a sample point (vertex) of triangulated isosurfaces on a cube edge from an underthreshold voxel 10 and an overthreshold voxel 12, and use sample points 11 to reconstruct isosurface triangles, as shown in FIG. 3A. The surface normal of an isosurface vertex is interpolated from the surface normals of two voxels, interpolating the isosurface vertex. The surface normal of a voxel is determined by the gradient of voxel values at the voxel.

In a volume coordinate system, neighboring voxels space in a unit indicates voxel coordinates are all integers. The positions and surface normals of the isosurface vertices are scaled into a world coordinate system in the aligned slices as shown in FIG. 3B. The scaling parameters comprise slice thickness and voxel width. The transformation is not a simple scaling, however, and is not identical everywhere in the unaligned slices. It varies according to the slice location and attitude, as shown in FIG. 3C. The invention uses a set of formulas (with parameters of slice attitude and position) to transform the voxel centers and surface normals thereof and interpolate the positions and surface normals of the isosurface vertices to obtain the isosurface triangles for shading.

Sample point determination is described as follows.

The example of stacking slices along the Y-axis is used to explain the computation for transformation. The computation is symmetric in the case of stacking slices along the X- or Z-axis. In this embodiment, X, Y, and Z represent the coordinates in the volume coordinate system, while x, y, and z represent the coordinates in the world coordinate system. origins of the two coordinate systems coincide. The slice axes (Y- and y-) of the two systems overlap.

The following formula is the transformation for every point in the volume coordinate to the world coordinate, a concatenation of one scaling, three rotations and one translation, represented as:

$$[ \begin{matrix}x \\ y \\ z\end{matrix} ] = T ( Po ) Rx ( α ) Ry ( β ) Rz ( θ ) {S}_{XZ} [ \begin{matrix}X \\ 0 \\ Z\end{matrix} ] .$$

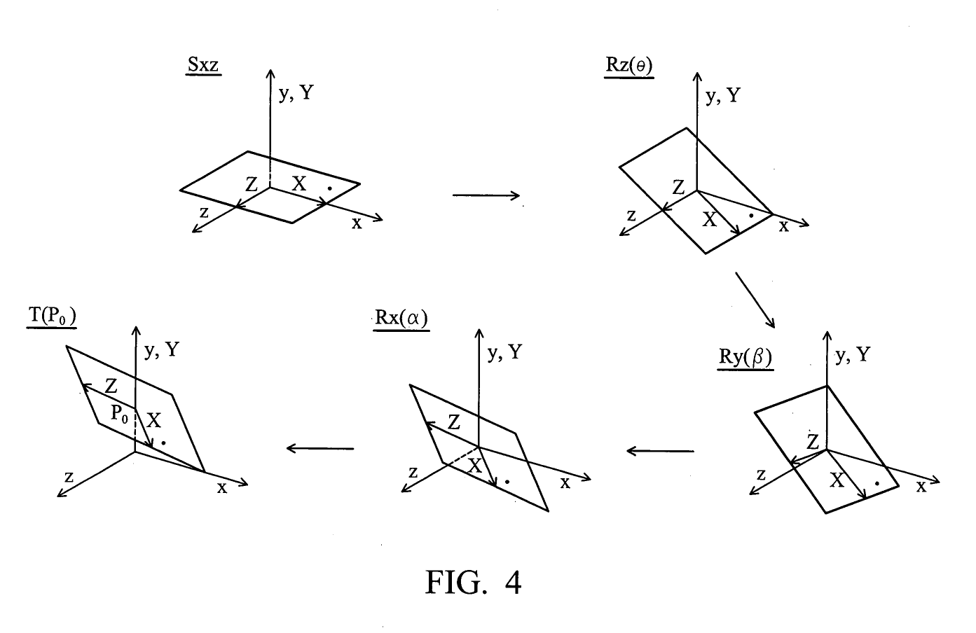

The geometric meanings of these rotation and scaling and translations are shown in FIG. 4. The scaling SXZ corresponding to the voxel width (FOV) is uniform for all slices. The three rotations, Rx(α), Ry(β) and Rz(θ), represent the attitude of a slice, the rotations of the x, y and z axis respectively. Po is the world coordinate of the slice center, X and Z coordinates there are always 0. The translation T(Po) translates the slice after the three rotations.

Surface normal calculation is described as follows.

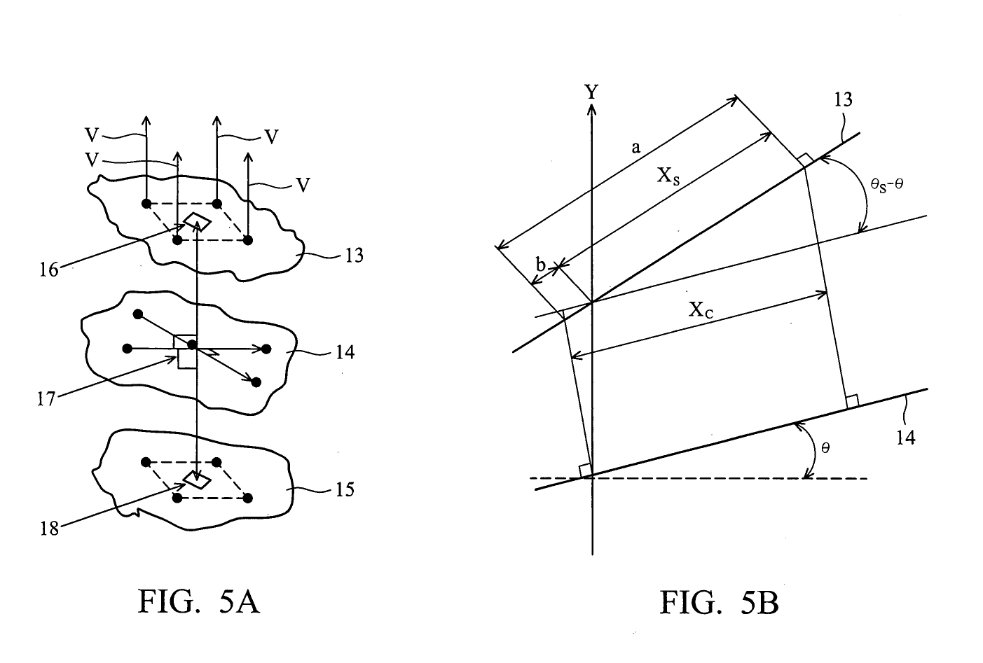

In the gradient method for the aligned slices, the x (or y or z) component of a surface normal at a voxel is determined from the subtraction of its positive neighbor voxel with its negative neighbor along the X (or Y or Z)-axis direction. The primary axes of the volume coordinate system are orthogonal in the aligned slices. Therefore, the subtraction of positive neighbors from negative neighbors of a voxel determines the gradient (surface normal) at the voxel. The primary axis along the slice (Y-) axis direction, however, may not be orthogonal to the other two axes in the unaligned slices, such that the subtraction of the neighbors along the slice axis cannot determine the gradient. The embodiment uses the surface normal of the slice 14 to determine one temporary neighbor voxel 16 on the superior slice 13 and another temporary neighbor voxel 18 on the inferior slice 15, as shown in FIG. 5A. Since the surface normal of the slice is orthogonal to the slice (X and Z) axes, the subtraction of the two temporary neighbors determines a component of the surface normal at the voxel. The other two components are obtained from the (X and Z) positive and negative neighbors on the slice. The intersection of the surface normal vector starting from the voxel with the neighbor slice is the position of the temporary neighbor. The distance between the two slices and the attitudes of the two slices determine the intersections, as shown in FIG. 5A.

Rotations of the y, x and z axis for the current slice 13 are Ry(β), Rz(θ), and Rx(α), respectively. Rotations of the y, x, and z axis for the superior neighbor slice are Ry(βs), Rz(θs) and Rx(αs), respectively. The volume coordinate ([Xs, Zs]) of the temporary neighbor is calculated from the slice distance (d) and the coordinates (X, Z) of the processed voxel using the following formulas:

$$[ Xc , Zc ] = Ry ( β s - β ) [ X , Z ] , \\ Xs = \frac{Xc}{cos ( θ s - θ )} - \frac{d sin ( θ )}{Sxz cos ( θ s - θ )} ( Fig . 3 ( B ) ) , and$$

$$Zs = \frac{Zc}{cos ( α s - α )} - \frac{d sin ( α )}{Sxz cos ( α s - α )} .$$

If the rotations of Ry(β) and Ry(βs) are identical, [Xc, Zc] equals [X, Z]. Zs is not affected by the rotation about the z-axis and Xs is not affected by the rotation about the x-axis. FIG. 5B demonstrates determination for Xs. The former part (Xc/cos(θs-θ)) in the formula indicates “a” and the latter part in the formula indicates “b” (obtained from the law of sine) Zs is determined according to the described process.

Xs and Zs are rounded off (as Xb and Zb) to determine the four voxels ([Xb, Zb], [Xb, Zb+1], [Xb+1, Zb], and [Xb+1, Zb+1], respectively) interpolating the value ([Xs, Zs]) of the temporary superior neighbor voxel 16. The position and value of the temporary neighbor voxel 18 on the inferior slice 15 are determined according to the described process. The calculated gradient corresponds to the volume coordinate and is then transformed into the world coordinate by multiplying the three rotations, Rx(α) Ry(β) Rz(θ).

Detection of intersection of neighboring slices is described as follows.

A topological error occurs when the topologic neighbor of a voxel is not in the proper position, indicating a topologically superior voxel (Y-axis neighbor) is actually geometrically inferior (-y-axis neighbor) or a topologically inferior voxel is actually geometrically superior. Different rotation angles of the x- or z-axis for any two adjacent slices result in such errors. As the result, the above sample point determination and surface normal calculation cannot be applied. If a voxel's X coordinate in a slice is smaller than dsin(90−θs)/Sxz sin(θ-θs) (obtained from the law of sine, as shown in FIG. 5C), or a voxel's X (Xs) coordinate in the superior slice is smaller than dsin(90+θ)/Sxz sin(θ-θs), topologic error occurs. The Z coordinates of the voxels resulting in such topologic errors is determined using the described process.

Feature recognition and automated diagnoses for unaligned slices are described.

The invention discloses a method of recognizing concave and convex features on boundaries of a vertebral body or inter-vertebral disc to extract pathological features on a transverse slice for spinal disease diagnoses. The volume (X and Z) coordinates of every boundary voxel of a vertebral body or inter-vertebral disc on a transverse slice are scaled to obtain slice coordinates (x and z) thereof using the following formula:

$$[ \begin{matrix}x \\ 0 \\ z\end{matrix} ] = Sxz [ \begin{matrix}X \\ 0 \\ Z\end{matrix} ] .$$

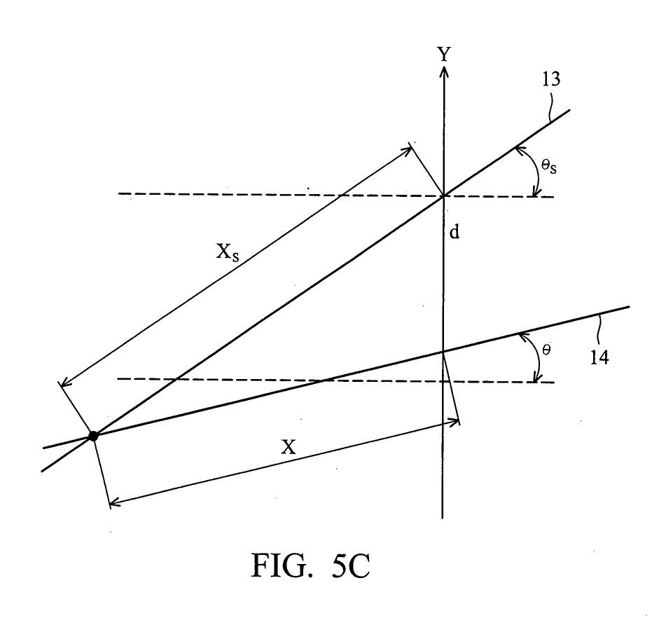

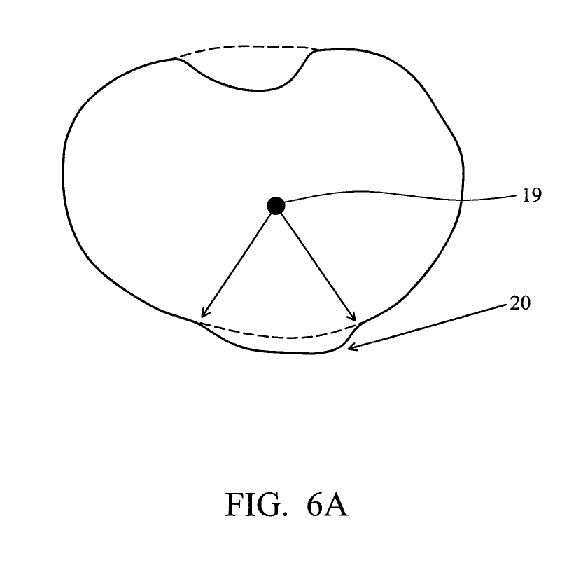

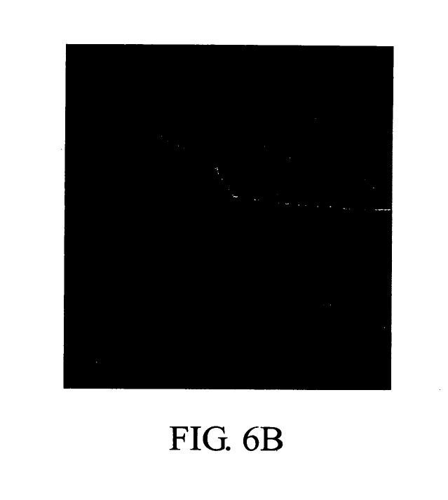

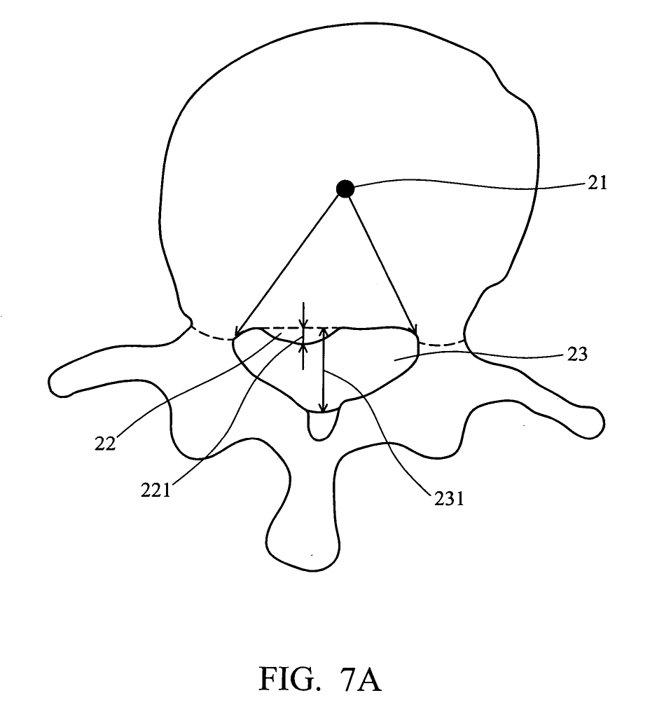

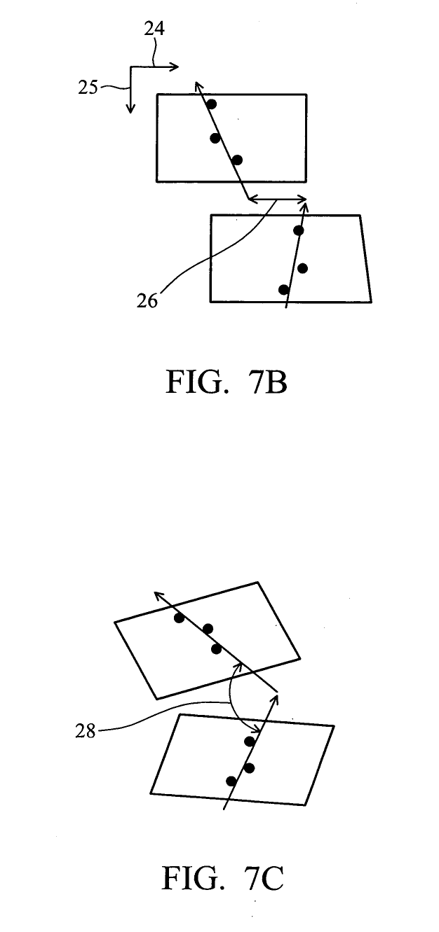

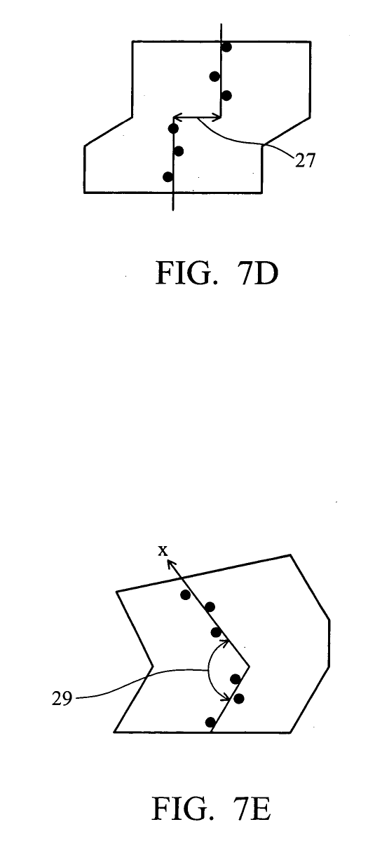

The boundary voxels are approximated using a B-spline radius and closed curve with fine approximation for circle, arc, sine, or cosine-like boundaries. The convex features 20 on an intervertebral disc boundary are matched into a disc herniation feature to diagnose HIVD, as shown in FIG. 6A. A concave feature 23 on a vertebral body is matched with the canal. Next, the compassion between compressed diameters and the normal diameter is enabled to determine the compressed ratio of the canal, as shown in FIG. 7A.

The spatial data of intervertebral disc and vertebral bones are calculated according to multiple transverse slices. However, for the unaligned slices, the slice coordinates must be transformed into the world coordinates by the following formula:

$$[ \begin{matrix}x \\ y \\ z\end{matrix} ] = T ( Po ) Rx ( α ) Ry ( β ) Rz ( θ ) [ \begin{matrix}x \\ 0 \\ z\end{matrix} ] .$$

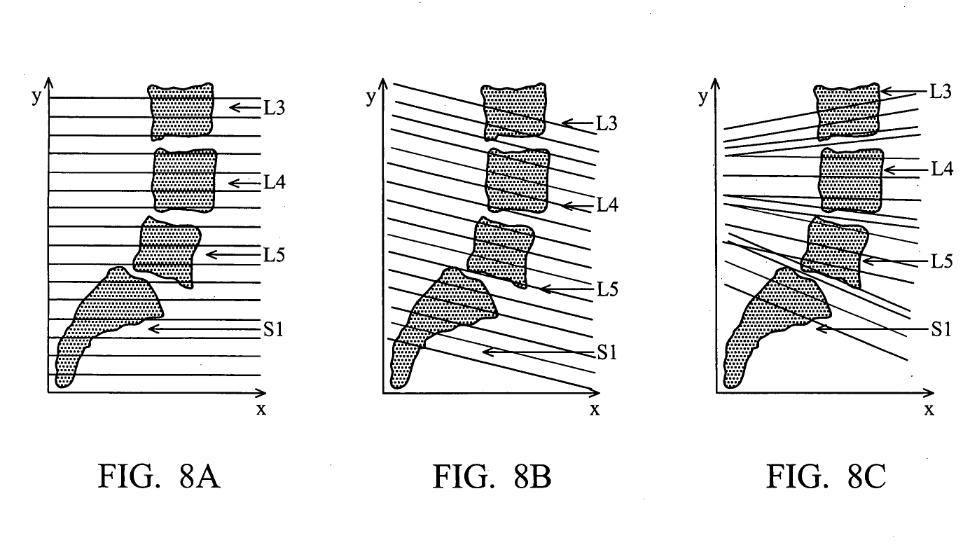

A 3D herniation shape is reconstructed using the world coordinates of the positions of disc herniations on respective slices, as shown in FIG. 8B. The centerlines of vertebral bodies are regressed according to the world coordinates of the centers of vertebral bodies on respective slices. These centerlines represent the heights and vectors of vertebral bodies and are compared with the normal spinal (first and second) curvature to enable diagnoses about various spinal diseases caused by abnormal spinal curves.

Four abnormalities are detected from the comparison of the normal and calculated spinal curves. A translation abnormality 26 between any two vertebral bodies indicates a shear translation at the intervertebral disc, as shown in FIG. 7B. If the translation is along the anteroposterior direction 24, a dislocation or subluxation is the result. If this translation is along the horizontal direction, scoliosis is the result. Angular abnormalities 28 and 29 (as shown in FIG. 7C) between any two vertebral bodies may be the result of a compression deformity at the intervertebral disc and bring scoliosis, kyphosis or, lorodosis. Translation abnormality 27 inside a vertebral body indicates a shear dislocation at the body, as shown in FIG. 7D. The deformity is caused by a fracture or tumor and results in a canal compression. Angular abnormality inside a vertebral body indicates a body deformation, induced by a fracture or spurs at the body (as shown in FIG. 7E) and result in scoliosis, kyphosis, lorodosis, or canal compression.

Materials and clinical application are described as follows.

Multiple patients undergo a CT examination (General Electric high speed CT/i) to obtain an arbitrary volume in which at least two slices are set to pass orthogonally through each structure (a disc space or vertebral body) Preceding the CT examination, clinical investigations are made to decide which disc spaces and vertebral bodies should be examined.

The visualization and feature recognition software is written with C++ and currently implemented on a P-IV 2.4 G with 1 Gbytes of main memory without special graphics hardware. The computer also transforms all CT slices in the DICOM protocol as PC files. Isosurface reconstruction for bones, disc spaces and the spinal root and cords from an unaligned volume with 20 slices can be reduced under 30 seconds. Rendition of these isosurfaces can be reduced under 0.5 second.. A perspective change requires isosurface rendition but no isosurface reconstruction. Comparing the isosurface reconstruction and rendition, the computation time for feature recognition is trivial. Diagnoses of spinal disorders are determined and selected based on the results by the feature recognition method. Surgical modalities based on the feature recognitions from the arbitrary volumes provide information needed for planning surgical procedures. Surgical modalities are simulated with the previously described simulator, allowing surgical instruments to cut virtual anatomic structures and simulating every procedure of the surgical modalities.

To Compare the results of 3D reconstructions and feature recognitions from the aligned and unaligned volumes, three patients undergo another CT examination to obtain a traditional aligned volume or an oblique volume. The slices of an aligned volume are all horizontal with constant intervals. The slices of an oblique volume have a constant interval and are orthogonal to the main structure (a disc space or vertebral body), considered to most involve the spinal disease during the clinical investigations.

The final diagnoses are confirmed by traditional clinical investigations and operative findings and are consistent with the diagnoses obtained by the 3D reconstruction and feature recognition method. All treatment outcomes are satisfactory at a mean follow-up period of 1.4 years (range, 1 to 2.5 years). The prospective planning using the data obtained from the feature recognition and evaluations using the arbitrary volume are compared with the result of operation for each patient. The patients 1, 5, 8, 11, and 13 have excellent results and patients 2, 3, 4, 7, 10, 12, and 15 have good results, and patients 6, 9 and 14 have fair results, indicating five (33.4%) outcomes are excellent, seven (46.6%) are good, and three have no improvement (20%). Individual steps of physical examination, CT imaging, evaluation, operative finding, and comparative study for each patient are shown in Attachment 1.

Three cases are given as examples, described in the following.

Three patients (Patient 1, 6, and 11 shown in Attachment 1) are the example cases. The first case comprises lumbar intervertebral bone and disc problems caused by subluxation. The second case comprises an intra-vertebral tumor problem. The third case comprises a cervical spondylosis problem.

Case 1 for the lumbar intervertebral disc and bone problem is described as follows.

A patient suffers from bilateral sciatica off and on with low back pain, abnormalities thereof comprising depression and tenderness over the L4 and L5 area, bending difficulty, mild atrophy of both. thigh muscle, weakness on dorsiflexion in both big toes and on right plantar flexion in the right big toe, Laseque's sign (positive finding with 40° elevation of the left leg and 50° elevation of the right and left leg), absence of knee jerk, hypoesthesia (sensory loss) of the L5 dermatome, and positive findings on lateral bending of the left and right leg, individually. Based on the clinical findings, diagnosis for the patient may be spondylolisthesis at the L4-5.

Three sets of CT (General Electric high speed CT/i) transverse slices are generated consecutively between L3 and S1. Each set consisted of 16 slices. The first set constituted an aligned volume with a constant interval and parallel to the horizontal plane, as shown in FIG. 8A. The second set comprises a constant interval but is oblique to the horizontal plane, as shown in FIG. 8B. The set is mainly orthogonal to the L4-5 disc space and the L5 vertebral bone. The third set comprises arbitrary interval and attitude (as shown in FIG. 8C), and 16 slices thereof are nearly orthogonal to the vertebral bones L3, L4, L5 or S1, and the disc spaces of L3-4, L4-5 or L5-S1, respectively.

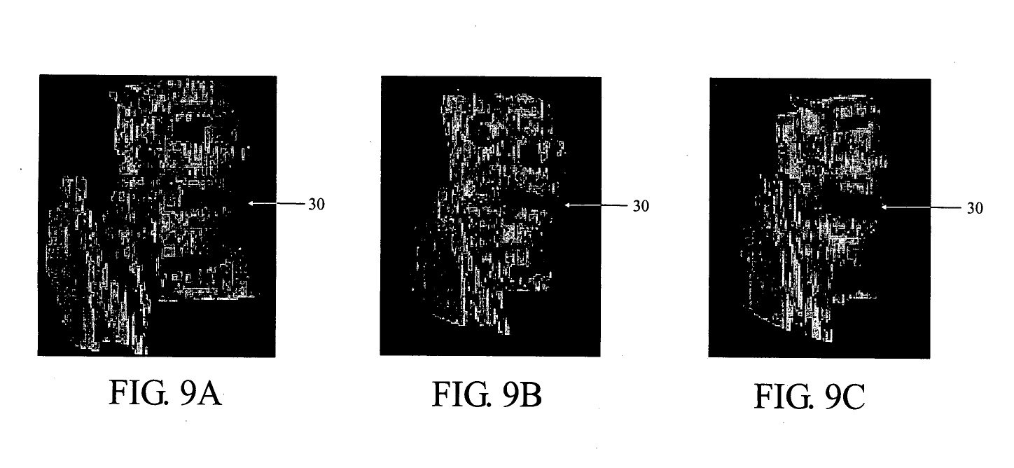

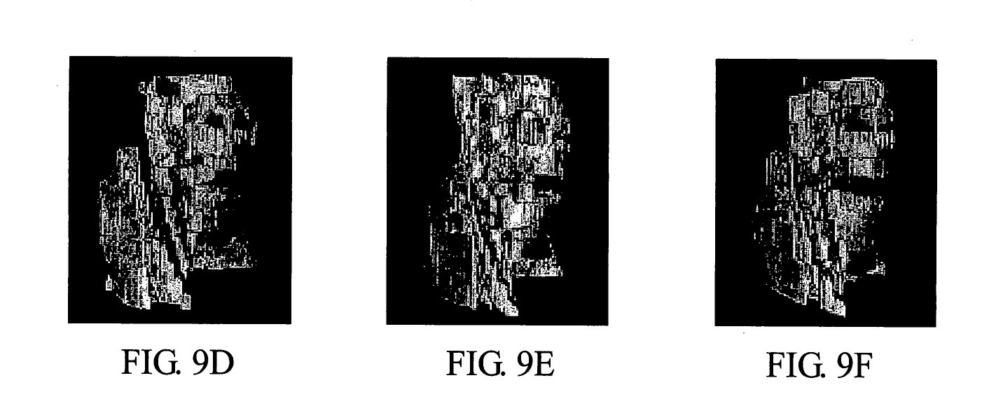

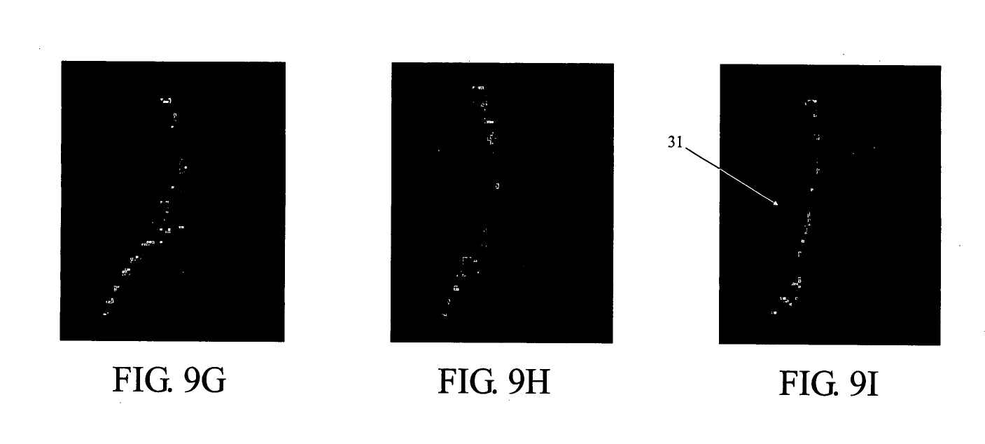

To obtain the threshold values of disc spaces and spinal roots and cords, the structures are bordered on all slices. FIG. 9A shows the 3D image of the aligned volume that can be generated from the MC or the study method, indicating a traditional aligned volume is considered as one case of unaligned volumes. FIG. 9B shows the 3D image of the volume with constant oblique angle and interval. FIG. 9C shows the 3D image of the volume with arbitrary angles and intervals. FIGS. 9D, 9E, and 9F show the 3D images of three constant interval 125-slice volumes interpolated from the original three volumes, respectively. The two interpolated volumes from the first and second volumes comprise the same constant angles as the original volumes and the third interpolated volume comprises slice angles, linearly interpolated from the original third volume. FIG. 9A and FIG. 9D and FIG. 9B and FIG. 9E are compared, showing interpolated volumes comprising smoother images but revealing the same bone morphology as the original volumes, demonstrating the interpolations cannot reveal more information. FIG. 9C and FIG. 9F, however, show little difference in bone morphology, indicating the interpolations of the angles may change the bone morphology. All the described figures show a subluxation 30 at the L4-5. Attachment 2 shows the calculated centers of L3, L4 and L5 at every slice and the centerlines of L3, L4 and L5 from the three volumes, respectively. Every vertebral body comprises near centerline value in each volume, such that the calculated body centerlines are near the same regardless of the number of slices used to resolve a body. The centerlines from the three volumes indicate a translation at the L4-5. The finding agrees with the 3D reconstruction from the three volumes. The angles between the L4 and L5 are 15.49, 14.44 and 15.23 degrees as calculated from the aligned, oblique and arbitrary volumes, respectively. The angles are near the normal angle. The translations at L4-L5 are 8.16 mm, 9.50 mm, and 10.00 mm from the aligned, oblique, and arbitrary volumes, respectively.

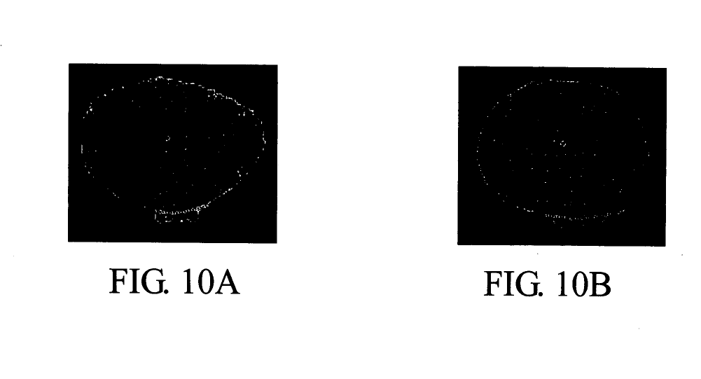

FIGS. 9G, 9H, and 9I show the 3D images obtained after augmenting the vertebral bodies to observe the relations between the spinal cord and roots with disc spaces. The figures are rendered from the aligned, oblique, and arbitrary volumes, respectively. Since the arbitrary volume resolves each disc space using two orthogonal slices, the disc space images in the arbitrary volume are more morphologically complete than in other volumes. The spatial relations of the cord and roots with the spaces and the ratios of the disc spaces to the vertebral bones are also more accurate in the arbitrary volume. Although a demonstration is not provided in the embodiment, the interpolated images are smoother than the non-interpolated ones but the same anatomic information regarding the spinal cord, roots and disc spaces are revealed. Referring to FIG. 9I, disc compression 31 on the spinal cord at the L4-5 is observed. The disc images, however, are not complete to reveal such herniation in FIG. 9G and 9H since slices thereof at the L4-5 are not perpendicular to the space (as shown in FIG. 9G) or the slice number at the L4-5 is too few (as shown in FIG. 9H). FIG. 10 shows two slices in the arbitrary volume with herniation discs agreeing with the result from the 3D image.

The results of 3D reconstruction and feature recognition from the arbitrary volume agrees the result of operative finding as shown in Attachment 1, indicating the accuracy of the method of the invention and a prototype system. The arbitrary slices and planed surgeries can be visualized using the system. The arbitrary slices. can be easily set to clearly resolve anatomically meaningful structures so that the result is better than that obtained from the slices with constant interval or angle. The constant-angle slices do not always clearly resolve anatomically meaningful structures.

Case 2 for the lumber tumor problem is described as follows.

A patient suffers from weakness, body weight loss, upper abdominal pain, and severe low back pain, abnormalities thereof comprising tenderness with hepatomegaly over the right upper abdomen, abdominal sonography showing abnormal shadow in the liver, and elevated tumor marker α-fetoglobulin (1020 ng/ml, much higher than the normal value (under 10 ng/ml)). The whole body bone scanning and plain X-ray also supported these clinical findings of hepatoma with a metastatic L4 or L5 bone tumor with pathological fracture.

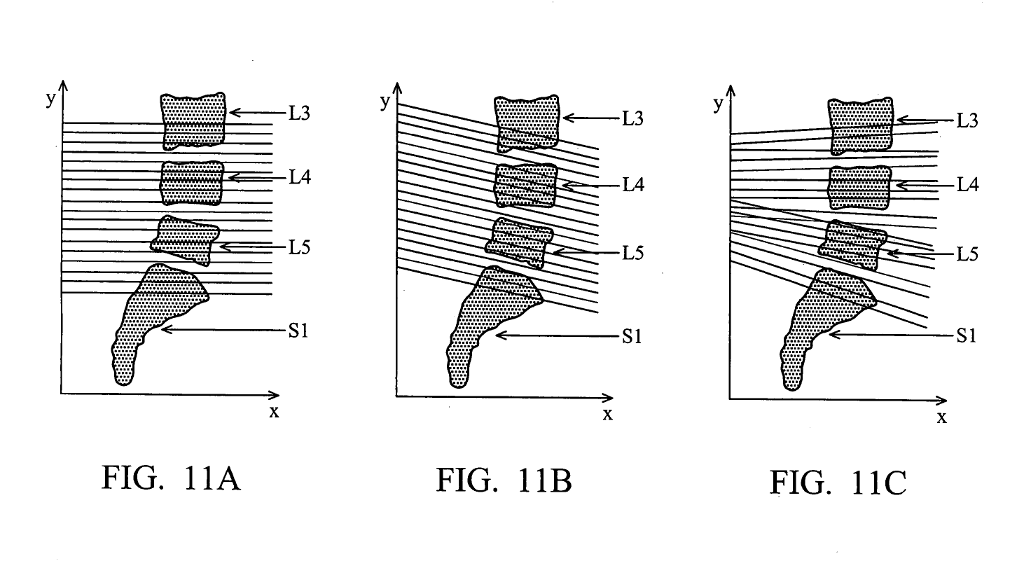

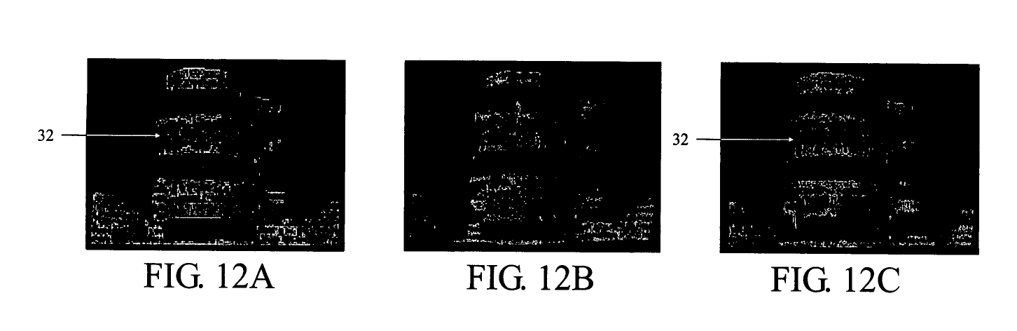

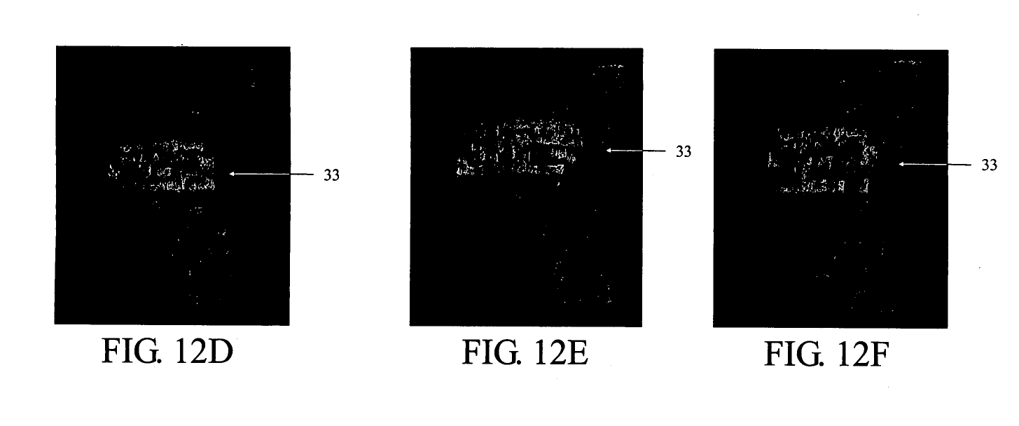

Three (aligned, oblique, and arbitrary) sets of CT transverse slices are generated consecutively between L3 and S1. Each set consists of 18 slices. The aligned volume is mainly orthogonal to the. L4 vertebral bone (as shown in FIG. 11A). The oblique volume is mainly orthogonal to the L5 (as shown in FIG. 11B). The slices of arbitrary volume are nearly orthogonal to the .L3, L4, L5 and S1, and the L3-4, L4-5 and L5-S1, respectively, as shown in FIG. 11C. FIGS. 12A, 12B, and 12C show the 3D images of the aligned, oblique, and arbitrary volumes, respectively. FIGS. 12D, 12E, and 12F show the 3D images after augmenting the vertebral bodies to observe the relations between the spinal cord and roots with disc spaces and the tumor. FIGS. 12A and 12C show the L4 comprises the same serious bone fracture due to the tumor 32. Only a small fracture at the L4, however, can be observed in FIG. 12B. All the three figures demonstrate a small bone fracture at the L5. Also from FIGS. 12D and 12F, the spinal cord and roots are seriously compressed at the L4, however, a small area of compression 33 shown in FIG. 10E can only be observed. Transverse slices from the aligned and arbitrary volumes also demonstrate such compression (not shown herein). The above results are in agreement with the operative finding.

The pathological characteristics of the disc herniations, bone compressions, and spinal curves from 3D images of various perspectives cannot be observed for any of the three volumes. Meanwhile, no pathological features of canal compressions, disc herniations, and abnormal spinal curves are recognized from the three volumes. The results of feature recognitions agree with the 3D images. In this case, the (arbitrary and aligned) volumes comprise slices to be orthogonal to the fractured vertebral bone and thus provide better pathological characteristics on the tumor-fractured bone to improve the diagnostic result.

Case 3 for cervical spinal cord spondylosis problem is described as follows.

A patient suffers from neck pain with numbness in both the two arms, pain radiating to the forearm and the first and second finger bilaterally, and hypoesthesia over areas C5, and C6.

Electromyography (EMG) and nerve conduction velocity (NCV) show C5, C6 radiculopathy. The preliminary diagnosis based on these clinical findings is spondylosis of C5-C6.

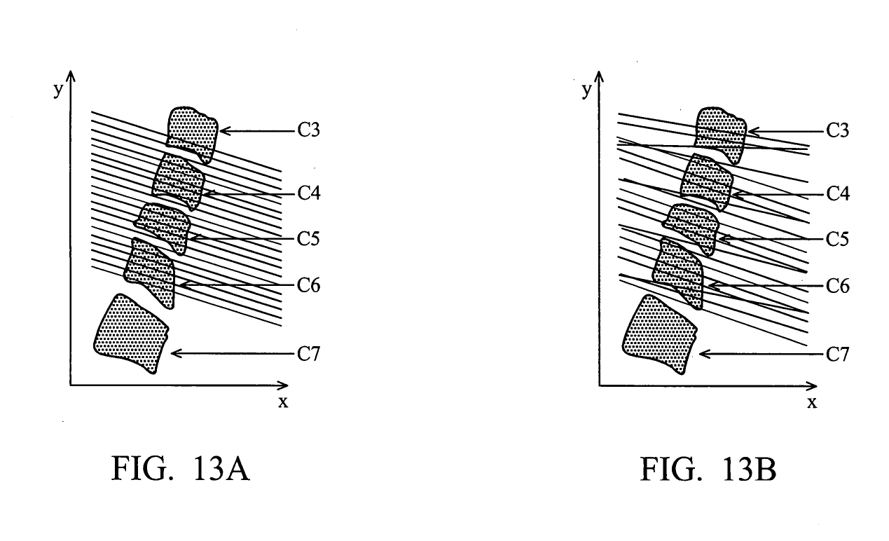

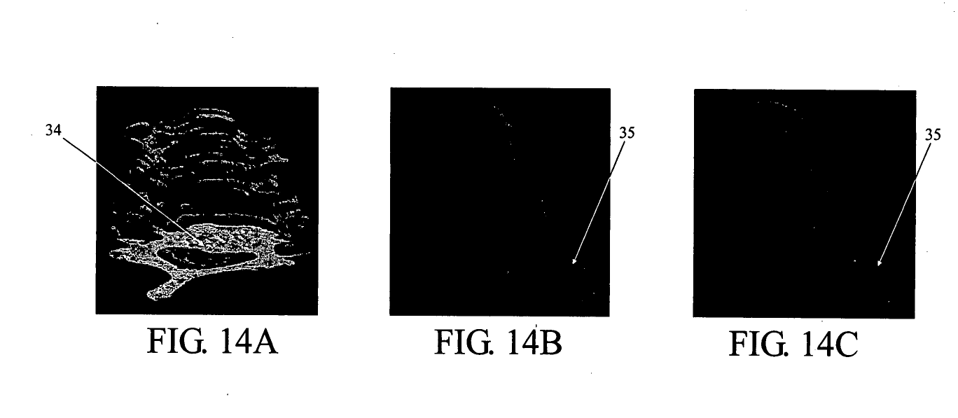

Two (oblique and arbitrary) sets of CT transverse slices are generated consecutively between C3 and C6. Each set consists of 20 slices. The slices of the arbitrary volume are near orthogonal to the C3, C4, C5, and C6, and the C3-4, C4-5, and C5-C6, as shown in FIG. 13A. The slices of the oblique volume are also near orthogonal to these structures, as shown in FIG. 13B. FIG. 14A shows a 3D image from the oblique volume. A similar image can be obtained from the arbitrary volume (not shown herein). A canal compression 34 pressing on the spinal cord can be observed. FIG. 14B and FIG. 14C show 3D images of the two volumes after bone augmentation. The figures show spinal cord narrowing at the C3-4, C4-5 and C5-C6, in agreement with the results of the clinical findings, the feature recognitions and, the operation. The disc spaces are not complete in the figures from the two volumes, considered the cervical disc spaces are not entirely disc-like. It is difficult to resolve a complete cross section of a cervical disc from a plan slice. The image from the arbitrary volume shows clearer pathological characteristics about the spondylosis 35 at the C5-6, as shown in FIG. 14C. The improved visualization can be considered as due to the more orthogonal position of the slices in the arbitrary volume to the cervical disc spaces than in the oblique volume.

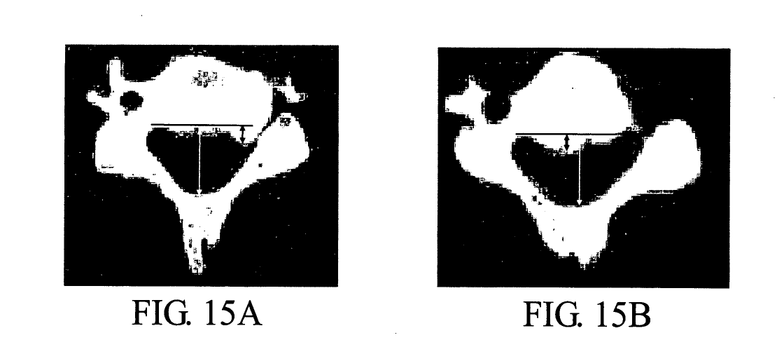

FIG. 15 shows two transverse slices from the arbitrary volume and the oblique volume located at the C4 and C5, respectively. The slices comprise the largest canal compression in the two volumes. Such canal compressions are recognized from other slices in the arbitrary volume, however, not recognized from other slices in the oblique volume. The reason for the symptom is considered as the more orthogonal position of the arbitrary slices resolving more clearly the cervical vertebral bodies.

The invention discloses 3D reconstruction and feature recognition methods using unaligned transverse slices. The characteristics of the 3D spine configuration (i.e., shape, size, and location), including bones, disc spaces, spinal cord and roots, and tumors, can be visualized the 3D reconstruction. The pathological characteristics on the transverse slices can be analyzed to diagnose spinal diseases caused by abnormal intervertebral bodies and disc spaces, and tumors using the feature recognition. The visualization and pathological feature extraction methods provide visual and quantitative geometric data on disc spaces, tumors and vertebral bones to accurately evaluate various spinal diseases.

3D reconstruction of the invention employs the Marching Cube algorithm to obtain the vertices to triangulate tissue surfaces for unaligned slices as the method used in traditional aligned slices and then transforms the vertices into proper positions. The topology among the vertices is considered unchanged during the transformation. As a result, the method of the invention is effective when the regions of interest in the slices do not intersect. Since the curvature of the spine is small, the regions of interest usually do not intersect. However, further study for the case of intersection of the regions of interest is required if the 3D reconstruction and feature recognition methods are applied to other organs.

The invention visualizes and analyzes unaligned transverse slices of the spine, used to quantitatively and qualitatively evaluate spinal diseases using unaligned slices as well.

Application of the invention with spinal diseases in disc spaces, vertebral bones or tumors allows sufficient visualization and evaluations of spinal herniation, tumor and spinal curve and canal compression. The use of unaligned slices can reveal more anatomic information than the use of aligned slices. Additionally, the invention assists the use of unaligned slices to enable precise diagnoses for spinal diseases.

Although the present invention has been described in terms of preferred embodiment, it is not intended to limit the invention thereto. Those skilled in the technology can still make various alterations and modifications without departing from the scope and spirit of this invention. Therefore, the scope of the present invention shall be defined and protected by the following claims and their equivalents.

What is claimed is:

1. A method for spinal disease diagnosis based on image analysis of unaligned transversal slices, reconstructing a 3D image of a bone structure, comprising:
extracting at least one transverse slice from the 3D image;
obtaining vertices of a triangulated isosurface from the transverse slice;
transforming the vertices to correct positions of unaligned slices in the bone structure;
calculating a surface normal of the vertices according to the correct positions; and
reconstructing the triangulated isosurface by interpolating according to the vertices.

2. The method for spinal disease diagnosis as claimed in claim 1, further comprising reconstructing the triangulated isosurface using a sample point, wherein the sample point is transformed from a volume coordinate system to a world coordinate system using a mathematical formula.

3. The method for spinal disease diagnosis as claimed in claim 2, wherein the transformation is implemented with a concatenation of a scaling operation, three rotation operations, and a translation operation.

4. The method for spinal disease diagnosis as claimed in claim 2, wherein the sample point is interpolated on a cube edge from an underthreshold voxel and an overthreshold voxel.

5. The method for spinal disease diagnosis as claimed in claim 1, wherein the surface normal is determined with subtracting a negative neighbor voxel value of a voxel from a positive neighbor voxel value thereof.

6. The method for spinal disease diagnosis as claimed in claim 1, wherein surface normal calculation further comprises detecting transverse slices with no intersection in regions of interests (ROI).

7. The method for spinal disease diagnosis as claimed in claim 1, wherein the transverse slice is obtained through computed tomography (CT) or magnetic resonance imaging (MRI).

8. The method for spinal disease diagnosis as claimed in claim 1, wherein the transverse slice is a 3D image.

9. The method for spinal disease diagnosis as claimed in claim 1, wherein the triangulated isosurface is reconstructed using interpolation.

10. An method for spinal disease diagnosis based on image analysis of unaligned transversal slices, implementing feature recognition to 3D volumes of a bone structure, comprising:
approximating the boundary of the bone structure as a radius;
transforming features and centers of the bone structure to correct positions on unaligned slices thereof;
determining attitudes and lengths of the bone structure according to the centers on the unaligned slices; and
implementing diagnosis based on the positions, attitudes, lengths, abnormalities, volumes of the bone structure.

11. The method for spinal disease diagnosis as claimed in claim 10, wherein approximation further comprises approximating closed B-spline curves associated with concave and convex features of the bone structure.

12. The method for spinal disease diagnosis as claimed in claim 10, wherein the diagnosis is implemented according to the positions and volumes of disc herniation, fractured bones, or compressed canal or tumor.

13. The system as claimed in claim 10, wherein feature recognition further comprises:
scaling volume coordinates of each boundary voxel of the bone structure to obtain image coordinates thereof;
approximating the boundary voxel using a B-spline curve;
comparing structural features on the boundary with herniated features of a intervertebral disc; comparing structural features on the bone structure with a canal;
comparing a compressed diameter of the canal on the transverse slice with a normal diameter to determine a compressed ratio of the canal;
reconstructing a 3D herination sharp according to world coordinates of herniation positions of the vertebral disk;
regressing a centerline of the bone structure according to the world coordinates of centers of the bone structure, wherein the centers indicate the heights and vectors of the bone structure;
comparing the heights and vectors with a normal spinal curvature.

14. The system as claimed in claim 10, wherein the abnormalities comprise positions and volumes of disc herniation, fractured or compressed canal or spinal cord, tumor, and attitudes and lengths of centerlines of the bone structure.
